(19) United States
(12) Patent Application Publication
(10) Pub. No.: US 2013/0332245 A1
(43) Pub. Date: Dec. 12, 2013

(54) Multi-Merchant Loyalty System

(71) Applicants: John Parker SHANNON, JR., Ottawa (CA); Ronald Lawrence Frank, North Vancouver (CA); Stephen Alexander Levely, Stoney Creek (CA)

(72) Inventors: John Parker SHANNON, JR., Ottawa (CA); Ronald Lawrence Frank, North Vancouver (CA); Stephen Alexander Levely, Stoney Creek (CA)

(73) Assignee: MoneyBar Rewards, Inc., Kanata (CA)

(21) Appl. No.: 13/907,633

(22) Filed: May 31, 2013

Related U.S. Application Data
(60) Provisional application No. 61/656,936, filed on Jun. 7, 2012.

(51) Int. Cl. G06Q 30/02

(52) U.S. Cl. CPC G06Q 30/0229
USPC 705/14.3

(57) ABSTRACT

A system and computer program product for differentiating reward programs that use the same identity holder. This differentiation allows different businesses to offer their own tailored rewards program while the consumer has the convenience of using a single identity holder. Moreover, the system and computer program product provide for integrating proximity and affinity into multi-business rewards programs. Finally, the system and computer program product provide for members of a consumer membership organization to receive rewards based on their membership, thus allowing the organization to receive financial incentives based on encouraging their members to shop at certain businesses.

### CROSS-REFERENCE TO RELATED APPLICATIONS

This application claims benefit of U.S. Provisional Application No. 61/656,936, filed Jun. 7, 2012, entitled “Multi-Merchant Loyalty System,” the contents of which are incorporated herein by reference in their entirety.

### BACKGROUND OF THE INVENTION

1. Field of the Invention

The present invention generally relates to customer loyalty programs and, more specifically, to customer reward programs.

2. Background Art

Customer loyalty programs have become a key business strategy for many of the most successful companies. Customer loyalty programs help companies develop stronger, lasting relationships with their best customers. Such programs are typically implemented as customer rewards programs.

A customer rewards program gives benefits or incentives to a customer that consistently buys at participating businesses. The provided incentives are designed to spur consumer loyalty for participating businesses. In the basic architecture, a single business offers a loyalty program where a customer accumulates points or status towards an eventual achievement. For example, a coffee shop may offer buy-ten-get-one-free coffee purchase programs.

The basic process involves an accumulation of points. Points may be accumulated based on discrete events, or scaled according to some factor such as number of cups of coffee purchased or distance traveled. The accumulation of points allows customers to earn rewards, which can be claimed in various ways. For example, a consumer may trade in some number of points to acquire a pre-defined benefit (e.g., 40,000 points for a free airplane ticket).

A single loyalty program may also be entered into by a plurality of businesses. In such a system, consumers end up accumulating points based on activity at diverse unaffiliated businesses, and potentially redeeming points and or enjoying benefits also at diverse businesses. For example, in a points accumulation loyalty program an individual consumer might purchase gasoline at a service station and earn five points, sporting goods at another location and receive fifty points, and fly to another city and earn 500 points. The rewards available to the consumer are based on the common denominator of the number of points awarded. In the common denominator system, the points earned at one business are ultimately indistinguishable from the points earned from another unrelated business

When such a scheme is tied exclusively to a single business, participation in such a program creates a strong incentive for a customer to direct their repeat business towards the offering business. However, where there are multiple businesses, consumer loyalty shifts towards the program itself. People who choose a business based on whether or not they accept a particular reward program do so not because they are loyal to that business but because they are loyal to the reward program. Where a business and all its competitors participate in the same rewards program, the program becomes a tax on the participating businesses profits without providing incremental value.

What are needed are systems and methods for businesses that allow them to offer their own tailored reward programs, while allowing their customers the convenience of using a single customer identity holder that works across other participating businesses. In other words, what is needed is a program that can be ubiquitously adopted by competing merchants without necessarily causing erosion of profits.

Furthermore, when it comes to small and medium-sized businesses, loyalty programs tend to be biased towards businesses catering to high-value purchases. For example, a single airplane trip often earns more points than a year's worth of coffee at a local coffee shop. However, the local coffee shop would be more inclined to confer rewards on consumers who every day purchase a cup of coffee, rather than on individuals who hop off a plane and purchase one cup of coffee only to never to be seen again. What are also needed are systems and methods that integrate proximity and affinity into the rewards program.

### SUMMARY OF THE INVENTION

The present invention provides systems and methods for a multi-merchant loyalty programs. In particular, the present invention provides systems and methods for differentiating reward programs that use the same identity holder. The present invention also provides for integrating proximity and affinity into multi-business rewards programs. Finally, the present invention provides for reward program feedback and incentives to consumer membership organizations.

Some benefits of the present invention include allowing different businesses to offer their own tailored rewards program while the consumer has the convenience of using a single identity holder, such as a rewards card. The present invention also supports offering a reward to a consumer for shopping at a given business, whereby the offer may be redeemed at another business based on its proximity or affinity to the original business. Finally, the present invention provides for members of a consumer membership organization to receive rewards based on their membership, and allowing the organization to receive financial incentives based on encouraging their members to shop at certain businesses.

Further embodiments, features, and advantages of the invention, as well as the structure and operation of the various embodiments of the invention are described in detail below with reference to accompanying drawings.

### BRIEF DESCRIPTION OF THE FIGURES

The present invention is described with reference to the accompanying drawings. In the drawings, like reference numbers indicate identical or functionally similar elements. The drawing in which an element first appears is indicated by the left-most digit in the corresponding reference number.

FIG. 1 provides a diagram of a multi-merchant loyalty system, according to an embodiment of the invention.

FIG. 2 illustrates a block diagram of a rewards management system, according to an embodiment of the invention.

FIG. 3 illustrates a block diagram of an exemplary computer system on which the embodiments can be implemented.

### DETAILED DESCRIPTION OF THE INVENTION

While the present invention is described herein with reference to illustrative embodiments for particular applications, it should be understood that the invention is not limited thereto. Those skilled in the art with access to the teachings provided herein will recognize additional modifications, applications, and embodiments within the scope thereof and additional fields in which the invention would be of significant utility.

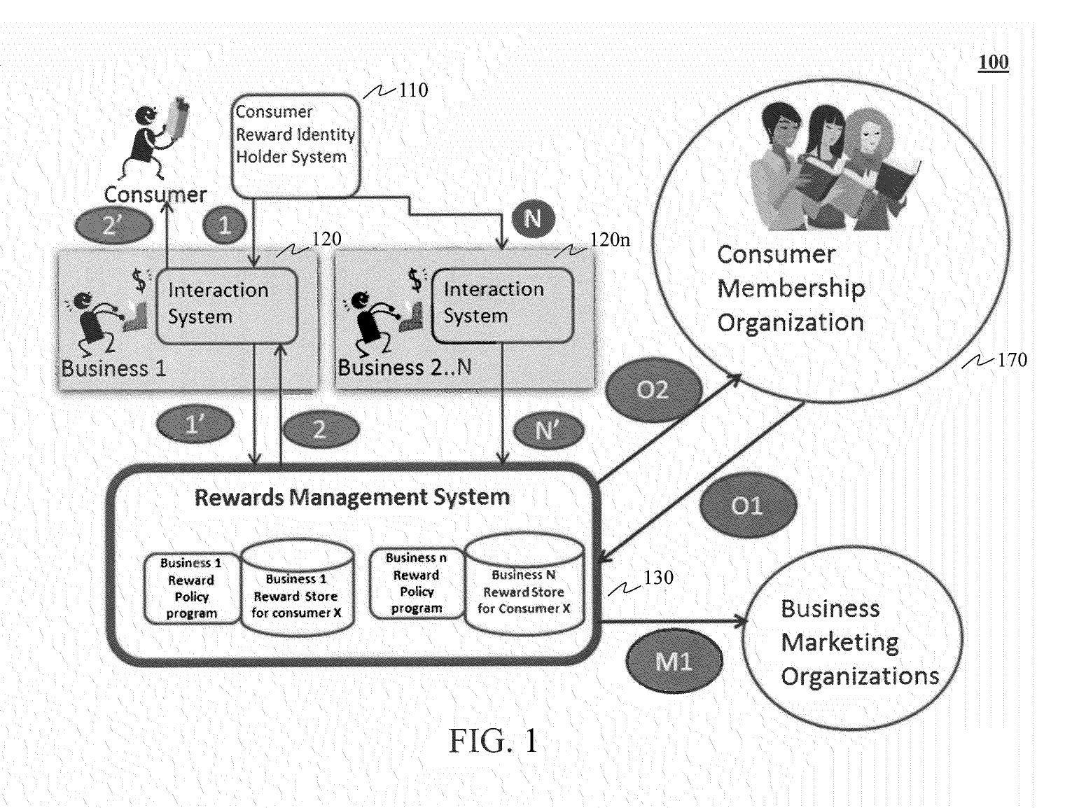

FIG. 1 is a block diagram of multi-merchant loyalty system 100. According to an embodiment, multi-merchant loyalty system 100 includes an identity holder 110, interaction system 120, interactions system 120n, and rewards management system 130. Interaction. systems 120 through 120n are located at businesses 140 through 140n. In embodiments, Multi-merchant loyalty system 100 supports many identify holders, such as identify holder 110 and many businesses, such as businesses 140 thru 140n.

Identity holder 110 associates a consumer with a rewards program. Identity holder 110 includes a consumer identifier and a reward identifier. The consumer identifier uniquely identifies the consumer to rewards management system 130. The consumer identifier may be, but is not limited to, an email address, driver's license, passport, telephone number or other identifier that uniquely identifies the consumer. The reward identifier represents a given rewards program that is managed by rewards management system 130. The reward identifier may be stored with the consumer identifier (e.g. a smartcard). In order to participate in multi-merchant loyalty system 100, consumers present their identity holder 110 at a point of sale when they purchase goods or services at business. As would be appreciated by a person of ordinary skill in the art, a point of sale may be, but is not limited to, a cash register, credit or debit point of sale terminal, or smartphone. Moreover, as would be appreciated by a person of ordinary skill in the art, identity holder 110 may be, but is not limited to, a magnetic card, smartcard, or smartphone.

Businesses 1 to n represent a collection of businesses. As would be appreciated by a person of ordinary skill in the art, a business may be, but is not limited to, a physical or virtual store that sells goods and/or services. Each business has its own tailored rewards program, but all the businesses' rewards programs are managed using a common rewards management system, such as rewards management system 130. In other words, rewards accumulated from one business are not commingled with rewards accumulated from other businesses. This is in contrast to existing systems where there may be different rates and mechanisms of reward accumulation for different participating businesses, but rewards accumulated from one business are commingled with rewards accumulated from other businesses. Moreover, because there is a common rewards management system, a consumer can make a purchase at business 1 using their identity holder and make another purchase at business N using the same identity holder.

At each business an interaction system 120 is used to report a purchase to rewards management system 130. Specifically, interaction system 120 reports the consumer and business identities and the purchase transaction details received at the point of sale to rewards management system 130.

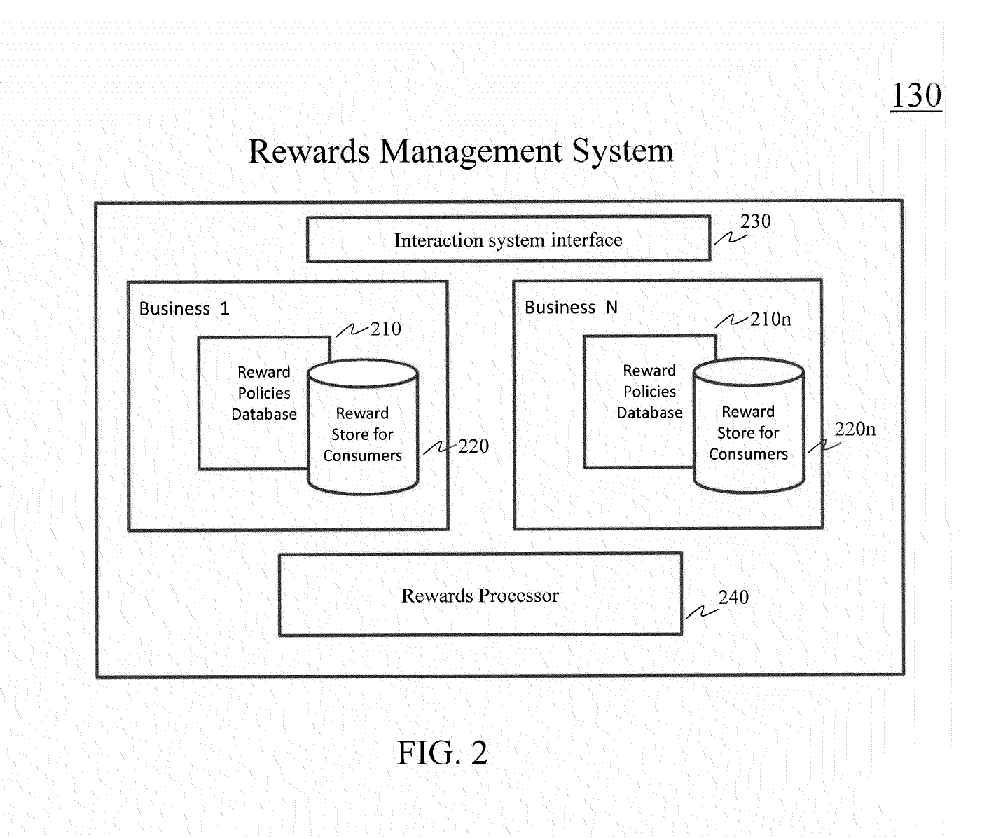

Rewards management system 130 maintains an accumulation of the history of each consumer's participation at each business. Specifically, rewards management system 130 includes separate reward stores for each consumer at each business and separate policies for each business. Referring to FIG. 2, rewards management system 130 includes reward policy databases 210 to 210n with corresponding reward stores 220 to 220n that record the reward accumulations for each business for each consumer. Each reward policy database is associated with a particular business. Reward stores 220 to 220n, include reward stores for each consumer that is receiving rewards from a particular business. The separate stores may be physically separated, or they may be virtually separated by data portioning and linkage within the same physical store. This approach allows a single reward program to provide different accumulation and redemption polices for different businesses all using the same consumer reward identity holder.

Additionally, rewards management system 130 includes interaction system interface 230 configured to receive transaction information from one or more businesses and rewards processor 240 configured to apply policies stored within the reward policy databases 210 thru 210n against transaction information to determine the rewards to store in the respective reward stores 220 thru 220n for individual customers for individual businesses.

In order to provide a custom tailored rewards program for each business, rewards management system 130 applies various policy programs based on the consumer and business identities as well as the purchase transaction details. The policies determine how rewards are accumulated and redeemed. Rewards may be calculated based on the identity and location of the business, the identity of the consumer, purchase transaction details, such as the time of day and type of purchase, and the consumer's purchase history. Whether rewards are accumulated or redeemed, the identity of the consumer and business are relied upon by the policy program to differentiate the resulting rewards between businesses and among consumers.

In another embodiment, reward management system 130 links the data and the policy programs, so that accumulation or redemption of rewards can be performed for a grouping of affiliated businesses. For example, grouping may involve a subsidiary and main business.

As a result, a large loyalty program that enrolls many businesses may be augmented, so that rewards earned at one business are differentiated from a consumer's activity at other businesses. Because rewards management system 130 maintains an accumulation of the history of each consumer's participation at each business, consumers end up with rewards that accumulate differently at different participating merchants, depending on that individual consumer's relationship with each of the different participating businesses.

According to another embodiment of the invention, proximity and affinity may be integrated into multi-merchant loyalty system 100. Specifically, reward management system 130 includes policy programs and protocols that offer a reward to a consumer for shopping at a given business whereby the offer may be redeemed at another business. The offer is presented at the point of purchase, but after the conclusion of the sale. The offer would typically be presented on the receipt or bill of sale.

The offer may be redeemed at another business if reward management system 130 has defined a relationship between a second business and the first business. The relationship may be any type that may be established algorithmically. In particular, the offer may be based on proximity (e.g. businesses with 20 miles of business N) or affinity (if business 1 is a bakery, the offer may be for businesses that sell fruit or produce, or specific business names that are defined in the reward management system to have affinity).

The proximity and affinity determinations are based on the received consumer and business identities as well as the purchase transaction details. For example, the received business identity may be used to lookup other businesses in rewards management system 130 that provide similar and or complementary goods and services. Alternatively, the business location may be used to lookup other businesses in rewards management system 130 that are within a certain radius of that business.

Because the offer is presented at the point of purchase, the offer occurs at a point of heightened consumer receptivity to such offers. In addition, because the offer is presented to the consumer after the sale, the offer does not create a disincentive to the first business because the offering business loses nothing by presenting the offer. Finally, because the offer is presented as a “thank you” from a third-party, without the control or foreknowledge of the consumer, there is less price erosion risk than a first party coupon offer.

According to another embodiment of the invention, the system includes policy programs and protocols to offer an incentive reward to a consumer for shopping at businesses 1 to N where reward management system 130 indicates that the consumer is a member in a Consumer Membership Organization, such as consumer membership organization 170. The consumer will be dynamically offered a reward at those businesses that have an affinity relationship defined with consumer membership organization 170.

Rewards management system 130 defines and manages the relationships between consumers, businesses, and consumer membership organizations 170. A plurality of consumer membership organizations 170 may exist and the same consumer may be a member of a multiplicity of organizations. Furthermore, a business may have affinity relationships defined with a multiplicity of consumer membership organizations.

Rewards management system 130 provides reporting mechanisms with programmable real time updates of the levels of business generated by the businesses or organization members and, optionally, financial rewards to a consumer membership organization. Rewards management system 130 optionally provides reports to the businesses, or other authorized third parties, on the level of business generated by the members of the consumer membership organizations, such as consumer membership organization 170.

By integrating consumer membership organizations into multi, merchant loyalty system 100, members of consumer membership organization 170 receive rewards based on their membership in the organization. Furthermore, the organization itself can receive financial incentives based on encouraging their members to shop at certain businesses (e.g. local merchants of a neighborhood association). Finally, the businesses benefit from the aggregate number of consumers brought to them by their consumer membership organization, such as consumer membership organization 170.

### Computer System Implementation

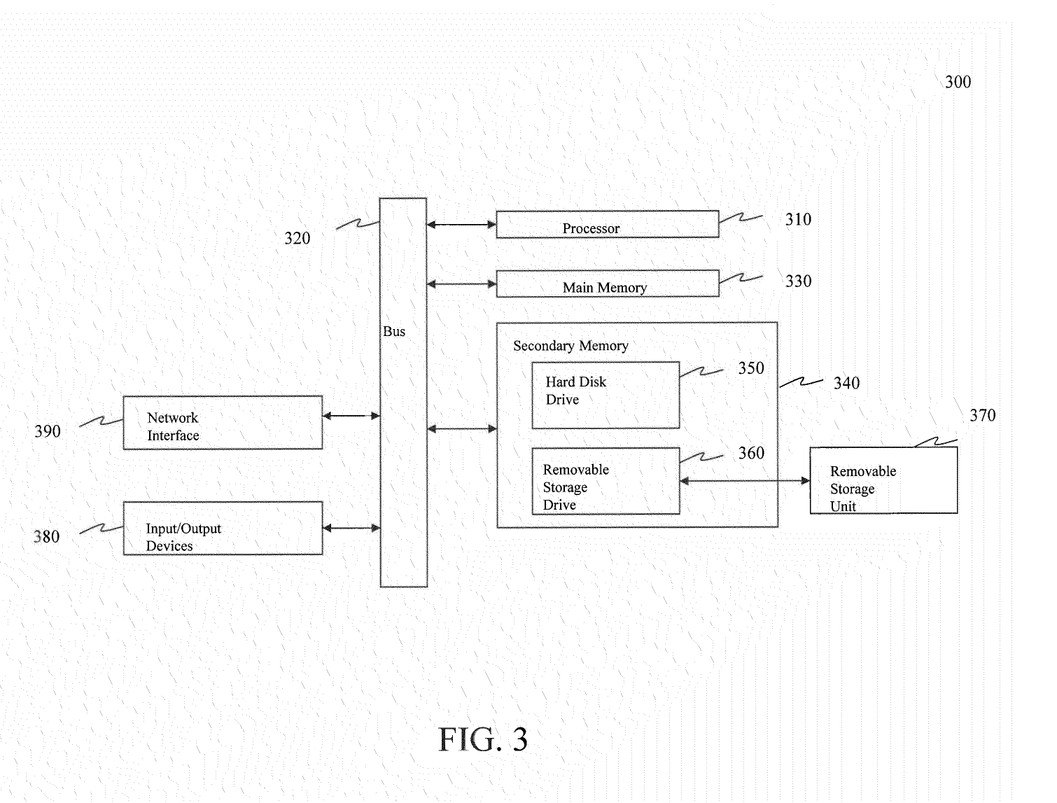

In an embodiment of the present invention, the methods and systems of the present invention described herein are implemented using well known computers, such as a computer 300 shown in FIG. 3. The computer 300 can be any commercially available and well known computer or server capable of performing the functions described herein, such as computers available from International Business Machines, Apple, Sun, HP, Dell, Cray, etc.

Computer 300 includes one or more processors (also called central processing units, or CPUs), such as processor 310. Processor 310 is connected to communication bus 320. Computer 300 also includes a main or primary memory 330, preferably random access memory (RAM). Primary memory 330 has stored therein control logic (computer software), and data.

Computer 300 may also include one or more secondary storage devices 440. Secondary storage devices 340 include, for example, hard disk drive 350 and/or removable storage device or drive 360. Removable storage drive 360 represents a floppy disk drive, a magnetic tape drive, a compact disk drive, an optical storage device, tape backup, ZIP drive, JAZZ drive, etc.

Removable storage drive 360 interacts with removable storage unit 370. As will be appreciated, removable storage unit 360 includes a computer usable or readable storage medium having stored therein computer software (control logic) and/or data. Removable storage drive 360 reads from and/or writes to the removable storage unit 370 in a well known manner.

Removable storage unit 370, also called a program storage device or a computer program product, represents a floppy disk, magnetic tape, compact disk, optical storage disk, ZIP disk, JAZZ disk/tape, or any other computer data storage device. Program storage devices or computer program products also include any device in which computer programs can be stored, such as hard drives, ROM or memory cards, etc.

In an embodiment, the present invention is directed to computer program products or program storage devices having software that enables computer 400, or multiple computer 400s to perform any combination of the functions described herein

Computer programs (also called computer control logic) are stored in main memory 330 and/or the secondary storage devices 340. Such computer programs, when executed, direct computer 300 to perform the functions of the present invention as discussed herein. In particular, the computer programs, when executed, enable processor 310 to perform the functions of the present invention. Accordingly, such computer programs represent controllers of the computer 300.

Computer 300 also includes input/output/display devices 380, such as monitors, keyboards, pointing devices, etc.

Computer 300 further includes a communication or network interface 390. Network interface 390 enables computer 300 to communicate with remote devices. For example, network interface 390 allows computer 400 to communicate over communication networks, such as LANs, WANs, the Internet, etc. Network interface 390 may interface with remote sites or networks via wired or wireless connections. Computer 300 receives data and/or computer programs via network interface 390. The electrical/magnetic signals having contained therein data and/or computer programs received or transmitted by the computer 300 via interface 390 also represent computer program product(s).

The invention can work with software, hardware, and operating system implementations other than those described herein. Any software, hardware, and operating system implementations suitable for performing the functions described herein can be used.

### CONCLUSION

Exemplary embodiments of the present invention have been presented.

The invention is not limited to these examples. These examples are presented herein for purposes of illustration, and not limitation. Alternatives (including equivalents, extensions, variations, deviations, etc., of those described herein) will be apparent to persons skilled in the relevant art(s) based on the teachings contained herein. Such alternatives fall within the scope and spirit of the invention.

The present invention has been described above with the aid of functional building blocks and method steps illustrating the performance of specified functions and relationships thereof. The boundaries of these functional building blocks and method steps have been arbitrarily defined herein for the convenience of the description. Alternate boundaries can be defined so long as the specified functions and relationships thereof are appropriately performed. Any such alternate boundaries are thus within the scope and spirit of the claimed invention. Thus, the breadth and scope of the present invention should not be limited by any of the above-described exemplary embodiments, but should be defined only in accordance with the following claims and their equivalents.

What is claimed is:

1. A reward management system, comprising:
an interaction system interface configured to receive transaction information from one or more businesses;
a plurality of reward policy databases, wherein each of the plurality of reward policy databases is associated with a business;
a plurality of reward stores, wherein each of the plurality of reward stores accumulates rewards associated with individual consumers activity with a business, wherein each reward store is associated with a respective policy database for a business; and
a rewards processor configured to apply policies stored within the reward policy databases against transaction information to determine the rewards to store in the respective reward store.

2. The reward management system of claim 1, wherein the rewards processor is further configured to apply policies stored within the reward policy databases against transaction information to offer rewards at a business different from the one or more businesses providing the transaction information.

3. The reward management system of claim 1, wherein the rewards processor is further configured to offer rewards at a business that is in geographical proximity to the one or more businesses providing the transaction information.

4. The reward management system of claim 1, wherein the rewards processor is further configured to offer rewards at a business that has affinity to the one or more businesses providing the transaction information.

5. The reward management system of claim 1, wherein the rewards processor is further configured to offer rewards to a consumer who is a member of a consumer membership organization, wherein the consumer membership organization has affinity with one or more businesses associated with the received transaction information.

6. A computer-readable storage device having computer-executable instructions stored thereon, execution of which, by a computing device, causes the computing device to perform operations comprising:
receiving transaction information from one or more businesses;
applying policy rules stored within a plurality of reward policy databases against transaction information;
determining rewards to store in a plurality of reward stores based on applied policy rules, wherein each reward store is associated with a respective policy database for a business.

7. The computer-readable storage device recited claim 6, wherein the policies stored within the reward policy databases are applied against the transaction information to offer rewards at a business different from the one or more businesses providing the transaction information.

8. The computer-readable storage device recited claim 6, wherein the policies stored within the reward policy databases are applied against the transaction information to offer rewards at a business that is in geographical proximity to the one or more businesses providing the transaction information.

9. The computer-readable storage device recited claim 6, wherein the policies stored within the reward policy databases are applied against the transaction information to offer rewards at a business that has affinity to the one or more businesses providing the transaction information.

10. The computer-readable storage device recited claim 6, wherein the policies stored within the reward policy databases are applied against the transaction information to offer rewards to a consumer who is a member of a consumer membership organization, wherein the consumer membership organization has affinity with one or more businesses associated with the received transaction information.
